(19) United States
(12) Patent Application Publication
(10) Pub. No.: US 2016/0092488 A1
(43) Pub. Date: Mar. 31, 2016

(54) CONCURRENCY CONTROL IN A SHARED STORAGE ARCHITECTURE SUPPORTING ON-PAGE IMPLICIT LOCKS

(71) Applicant: Futurewei Technologies, Inc., Plano, TX (US)

(72) Inventors: Jason Yang SUN, Palo Alto, CA (US); Guogen ZHANG, San Jose, CA (US)

(21) Appl. No.: 14/497,960

(22) Filed: Sep. 26, 2014

(51) Int. Cl. G06F 17/30

(52) U.S. Cl. CPC G06F 17/30362; G06F 17/30371

(57) ABSTRACT

Presented systems and methods can facilitate efficient and effective information storage management. A system may include a plurality of nodes, shared storage and a centralized lock manager. A storage management method can include: receiving an access request to information, performing a lock resolution process; and performing an access operation (e.g., read, information update, etc.). The information can be associated with a shared storage component. The lock resolution process can include participating in a lock management process that manages a physical lock (P-lock), wherein the lock management process utilizes transaction information associated with an implicit lock process and proceeds without communication overhead associated with explicit requests for a logical lock. In one embodiment the lock resolution process includes participating in a conflict determination process to determine if there is a potential conflict with an information access request, wherein the conflict determination process utilizes the transaction information associated with the implicit lock process.

### TECHNICAL FIELD

The present disclosure relates generally to the field of shared data clusters and more specifically to the field of managing concurrency in a shared data cluster.

### BACKGROUND

Two conventional architectures that can be used to handle scaling of capacity and availability of a database in a cluster environment (when one database system is hosted by multiple computing systems) include “shared-disk” and “shared-nothing” architectures. In the shared-nothing architecture, each computing system has exclusive access to any storage and data assigned to it. In the shared-disk architecture, a storage system for a database is shared by multiple computing systems and data can be accessed by all systems. Since the data can be accessed concurrently by multiple systems in a shared-disk cluster environment, care should be taken to avoid conflicting modifications of the data.

Some conventional approaches attempt to manage memory accesses using locks. In a single machine system, concurrent updates can be handled using locks. An on-page synchronization mechanism can also be used. For example, one conventional process uses a record header to record the transaction ID that modified the record. When a new transaction attempts to update the same record, it will wait for its completion (commit or abort) by using a transaction lock with the transaction ID in the lock manager. Many traditional lock approaches become significantly more complex and complicated in a shared resource environment. In a multi-machine shared environment locks can be maintained in a central location or in a distributed manner. However, conventional attempts that involve centralized and distributed lock approaches typically consume significant resources and incur performance impacts associated with lock management and maintenance overhead.

Two example approaches to information access management in a typical conventional shared-disk cluster approach include centralized lock management and distributed concurrency and coherence. In a centralized model, concurrency is controlled by using a global logical-lock (also known as an L-lock) while buffer coherency is managed by using a global physical-lock (also known as a P-lock). The L-lock is generally considered longer lived and is usually not released until the transaction is committed or rolled back. The P-lock is generally considered short-lived and is typically held only during the process of reading or updating the page (e.g., like a latch, etc.).

If two transactions are trying to update a same record on a same page, in a conventional approach a logical lock is needed to prevent the two transactions from interfering with each other. The lock can ensure only one transaction is processed at a time. The second transaction has to wait until the first transaction finishes. Meanwhile a physical lock can be used to provide physical consistency. Because data is stored into pages, when a record on a page is to be updated, another transaction trying to update another record on the same page will cause a physical conflict. Only one transaction at a time can update records on a particular page. In other words, even if the two transactions are not conflicting at a logical level (that is attempting to update different records), they can be conflicting at a physical level because only one transaction can update a page at a time. In conventional lock attempts, a transaction typically always applies for an L-lock first regardless of whether there is a conflict or not, and then a P-lock to get a hold of an up-to-date page for updating. These conventional requests for locks can impact latency and performance (e.g., transaction throughput, etc.).

### SUMMARY OF THE INVENTION

Presented systems and methods can facilitate efficient and effective information storage management. In one embodiment, a system includes a plurality of nodes, shared storage, and a centralized lock manager. In one embodiment, a storage access process includes: receiving an access request to information, performing a lock resolution process, and performing an access operation (e.g., read, information update, etc.). The information can be associated with a shared storage component. The lock resolution process can include participating in a lock management process that manages a physical lock (P-lock), wherein the lock management process utilizes transaction information associated with an implicit lock process and proceeds without communication overhead associated with explicit requests for a logical lock. It is appreciated the lock management process is compatible with granting various physical locks (e.g., Exclusive (X) P-Lock, Shared (S) P-Lock, etc.). In one embodiment, the lock resolution process includes participating in a conflict determination process to determine if there is a potential conflict with an information access request, wherein the conflict determination process utilizes the transaction information associated with the implicit lock process. In one exemplary implementation, overhead associated with explicit requests for a logical lock is reduced or avoided if the conflict determination process determines there is not a potential conflict. In one embodiment, in rare instances where there is a conflict at a logical level, a pseudo logical lock (L-lock) based on a transaction approach is utilized (rather than a conventional L-lock based on a record approach).

### BRIEF DESCRIPTION OF THE DRAWINGS

Embodiments of the present disclosure will be better understood from the following detailed description, taken in conjunction with the accompanying drawing figures in which like reference characters designate like elements and in which:

FIG. 1 illustrates a block diagram of an exemplary shared storage architecture in accordance with an embodiment of the present disclosure.

FIG. 2 is a block diagram of an exemplary access process in accordance with one embodiment of the present invention.

FIG. 3 is a block diagram of an exemplary processes in a lock resolution process in accordance with one embodiment of the present invention.

FIG. 4 is a flow chart of an exemplary potential conflict determination process in accordance with one embodiment of the present invention.

FIG. 5 is a flow chart of an exemplary lock resolution process in accordance with one embodiment of the present invention.

FIG. 6 is a flow chart of an exemplary process of node participation in a local lock resolution process in accordance with one embodiment of the present invention.

FIG. 7 is a flow chart of an exemplary process of node participation in a read access request for information in accordance with one embodiment of the present invention.

FIG. 8 is a flow chart of an exemplary process of node participation in an update/modification access request for information in accordance with one embodiment of the present invention.

FIG. 9 is a flow chart of an exemplary process of a centralized lock management participation in an access request for information in accordance with one embodiment of the present invention.

FIG. 10 illustrates an exemplary process flow for a P-lock request received by a node from a centralized lock manager in accordance with one embodiment of the present invention.

FIG. 11 illustrates an exemplary process flow in accordance with one embodiment of the present invention.

FIG. 12 illustrates conventional L-Lock approach overhead not required in newly presented approaches.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments of the present disclosure facilitate efficient and effective management and coordination of access to information in a shared storage architecture. In one embodiment, a centralized lock management component and information associated with an on-page implicit locking mechanism are utilized in managing information access requests. In one exemplary implementation, a locking scheme facilitates the issuance of physical locks (e.g., P-locks, etc.) while avoiding traditional overhead associated with logical locks (e.g., L-locks). The avoidance of overhead can include reduction in the number of messages associated with concurrency control and buffer coherency compared to conventional approaches. In one embodiment, the avoidance or reduction of overhead can also include reduced lock table sizes. It is appreciated the presented improvements can facilitate increased system throughput and increased overall system performance. Additional explanation is set forth in later portions of the detailed description.

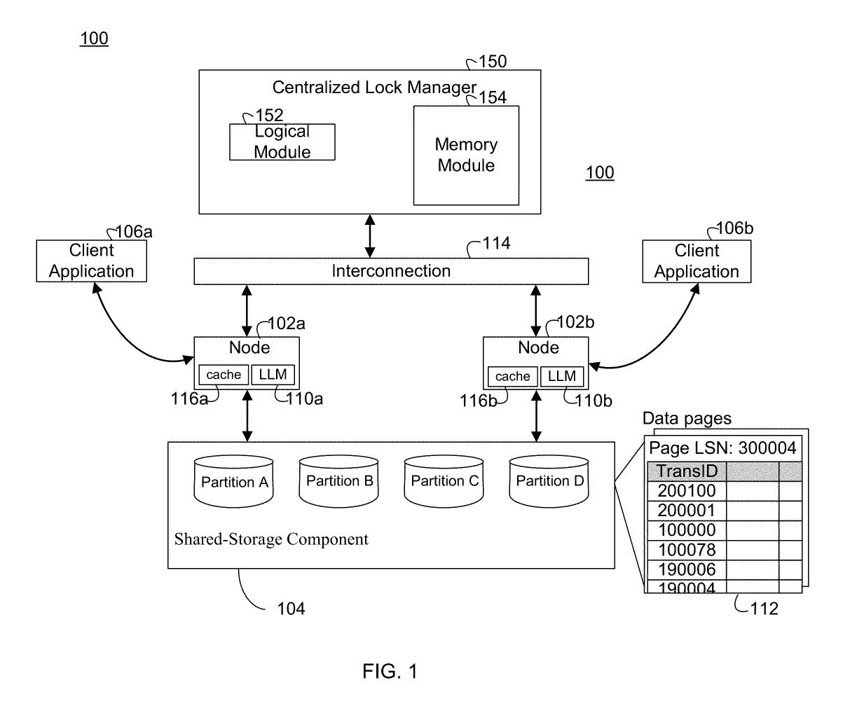

FIG. 1 is a block diagram of an exemplary shared storage architecture 100 in accordance with one embodiment of the present invention. Shared storage system 100 includes a centralized lock manager 150, shared storage 104, interconnection 114, and multiple nodes (e.g., 102a, 102b, etc.). The nodes 102a and 102b are coupled to shared storage 104 and interconnection 114 which is coupled to centralized lock manager 150.

The components of shared storage architecture 100 cooperatively operate to facilitate efficient and effective access to information in shared storage 104. In one embodiment, various components of shared storage architecture 100 participate in information access processes. Shared storage 104 stores information that may be shared with various other components (e.g., node 102a, node 102b, etc.) under appropriate circumstances (e.g., authorized for access, proper locks, etc.). The nodes (e.g., node 102a, 102b, etc.) can perform processing for client applications (e.g., 106a, 106b, etc.), including processing based on information stored locally in a node (e.g., in cache 116a, 116b, etc.). The information stored in a node can include information retrieved from another component (e.g., shared storage 104, another node, etc.). Centralized lock manager 150 can coordinate and manage information access requests between components (e.g., node 102a, node 102b, shared storage 104 etc.). Various components (e.g., node 102a, node 102b, centralized lock manager 150, etc.) may be communicatively coupled or interconnected via interconnection module 114. Additional explanation of various aspects of the components is set forth in later portions of the detailed description.

In one embodiment, a node (e.g., 102a, 102b, etc) is a processing or compute node that is operable to perform various operations, including participating in information access requests. It is appreciated a node can include a processing component in a variety of configurations (e.g., implemented as a virtual machine, as a hardware module, a processor, an application specific integrated circuit (ASIC), etc.). A node can also include a memory configured to store various information for the processing component, including information associated with various instructions and the operations (e.g., operations directed to participating in a lock resolution process, etc.).

While two nodes 102a and 102b have been illustrated in FIG. 1, any number of nodes may be included in a presented system or architecture. In one embodiment, a client application (e.g., 106a, 106b, etc.) may be included in or connected to a node (e.g., 102a, 102b, etc.). A client application (e.g., 106a, 106b, etc.) may submit a transaction to a node for processing and the transaction may include a request for access to information. In one embodiment, a node can be configured to run an agent that interacts with the client application and forward information access requests. The information access request by a first node (e.g., node 102a) can be directed to information available locally in the first node itself or can be directed to information in another component (e.g. shared storage 104, cache 116b of node 102b, etc.). In one embodiment, a node participates in a lock resolution process (e.g., P-lock process, etc.) when attempting to access information. In one exemplary implementation, a node can participate in local lock management processes (e.g., utilizing respective local lock managers 110a, 110b, etc.) and also participate in centralized lock management processes (e.g., by communicating with centralized lock manager 150). A local lock manager (e.g., 110a, 110b, etc.) can coordinate lock communications between centralized lock manager 150 and a respective node (e.g., node 102a, 102b, etc.) corresponding to the local lock manager. In one embodiment, a local lock manager is implemented in a processing component of the node. Additional explanation of various aspects of locking mechanisms and lock resolution processes is set forth in later portions of the detailed description.

Centralized lock manager 150 participates in lock management processes for system 100. In one embodiment, the centralized lock manager 150 is a global lock manager (GLM) and manages physical page locks (P-locks) for the entire system 100. In one exemplary implementation, centralized lock manager 150 provides concurrency controls. When a transaction attempts to access information (e.g., associated with a particular record, etc.) from another component (e.g., from shared storage 104, cache in another node, etc.), a P-lock is requested from the centralized lock manager 150. In one embodiment, centralized lock manager 150 determines if there is a conflict with granting a lock to a requesting component. In one exemplary implementation, a centralized lock manger maintains a centralized lock table and checks the centralized lock table to determine if there is a conflict. If there is not a conflict, centralized lock manager 150 manages granting of a P-lock to the requesting component. In one embodiment, centralized lock manager 150 participates in information access processes and corresponding lock resolution processes. Additional explanation of various aspects of lock resolutions processes is set forth in later portions of the detailed description.

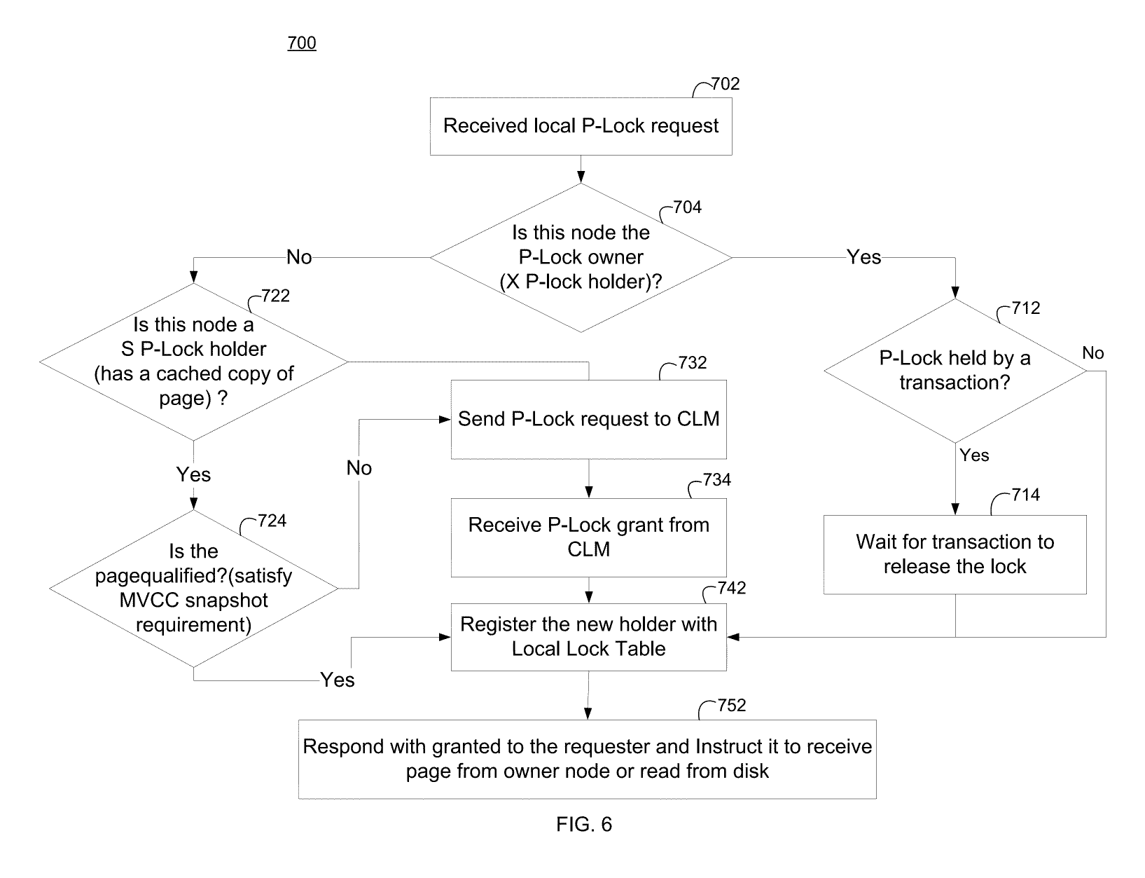

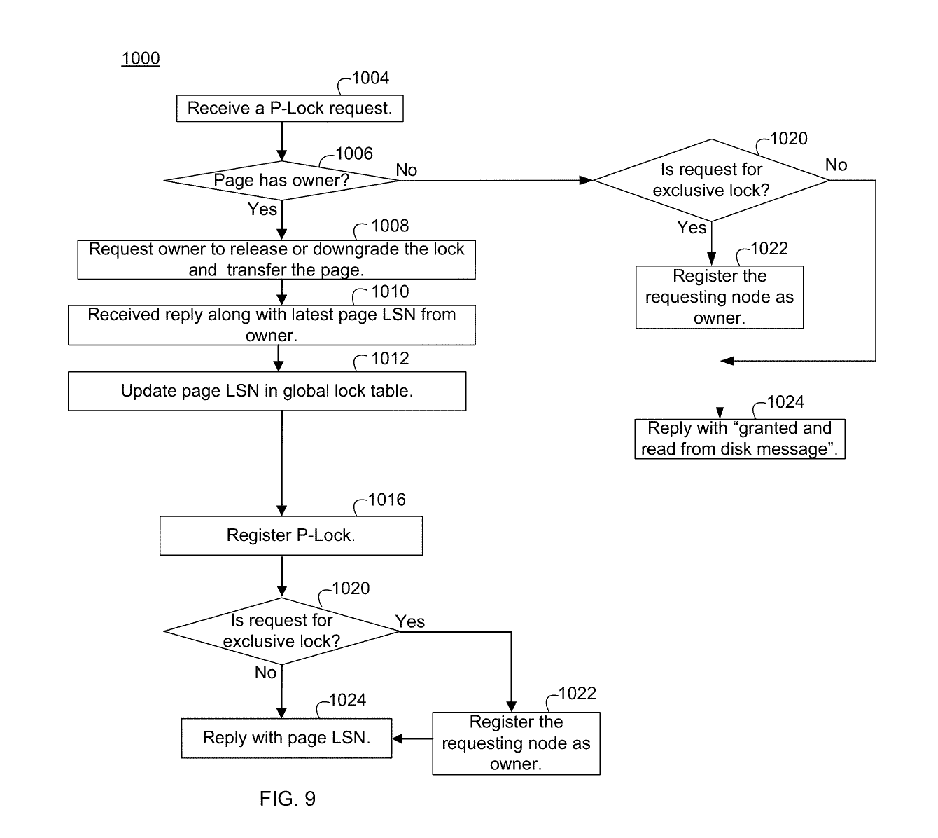

Centralized lock manager 150 may comprise a logical module 152 for managing P-lock requests (e.g., as illustrated in FIGS. 6, 9, etc.). It is appreciated, the logical module 152 may be implemented in various configurations (e.g., as a virtual machine, as a hardware module, a processing component, an application specific integrated circuit (ASIC), etc.). The centralized lock manager 150 may also comprise a memory module 154 for storing various information utilized in the performance of centralized lock manager 150 operations, (e.g., a list of nodes waiting to own a particular page, granted locks, instructions for participating in a lock resolution process, etc.). It is appreciated, the memory module 154 may be implemented in various configurations (e.g., random access memory (RAM), flash memory, cache, hard disk, etc.).

Shared storage 104 stores information that may be shared with various other components. It is appreciated shared storage 104 can include a variety of components (e.g., disks, flash, RAM, etc.) in various storage system configurations (e.g., partitioned configurations, cluster arrangements, server architectures, etc.). The components of shared storage 104 can be in one location or can be remotely located from one another. In one embodiment, shared storage 104 is configured in a shared disk cluster arrangement. In one exemplary implementation, shared storage 104 can be partitioned (e.g., partitions A, B, C, D, etc.).

It is appreciated information in system 100 can be organized in a variety of manners. In one embodiment, a storage address corresponds to a storage location and a portion of information storage (e.g., one or more storage addresses, etc.) corresponds to a record. In one exemplary implementation, a plurality of records or storage location addresses may be organized into a page and there can be one or more pages of stored information. The size or number of records or storage locations in a page is configurable. In one embodiment, one or more pages constitute a table (e.g., page table 112 in FIG. 1, etc.). Each page can have a page update sequence number, also known as a log sequence number (LSN), which provides a sequence number (e.g., 300004, etc.) for a page. Each time a page is updated, the page LSN is also updated. In one exemplary implementation, this allows updates on a page to be uniquely identified. In one embodiment, a page LSN is a monotonically increasing number corresponding to log records of a last update. Each record on the page has a header including a transaction ID field indicating the last updating transaction (e.g., 200100, 200001, 100000, etc. in Page 112). Each node (e.g., 102a, 102b, etc.) can maintain its own log for performance. The page LSN corresponds to a logical address of a log number of the update to the merged log file. In at least some situations (e.g., tracking information associated with implicit locks, etc.) the status of a transaction can also be centrally maintained (e.g., by central lock manager 150, etc.), and cached by local transaction manager.

As indicated above, various components of shared storage architecture 100 can participate in information access processes. In one embodiment, the operations and extent of participation of a particular component in a specific information access process and lock resolution process depends upon a variety of conditions. In one exemplary implementation, a particular node initially attempts a local access process. If the information is available locally the node performs a local access process and if the information is not available locally at the particular node, that node attempts to retrieve the information from another component (e.g., a shared storage, another node. etc.) by participating in a central access process. The status of the information (e.g., exclusively owned, shared, etc.) can also impact the extent of participation (e.g., particular operations, etc.) of a component (e.g., a central lock manager, a node, etc.) in an information access process. Additional explanation of various aspects of information access processes and lock resolutions processes is set forth in later portions of the detailed description.

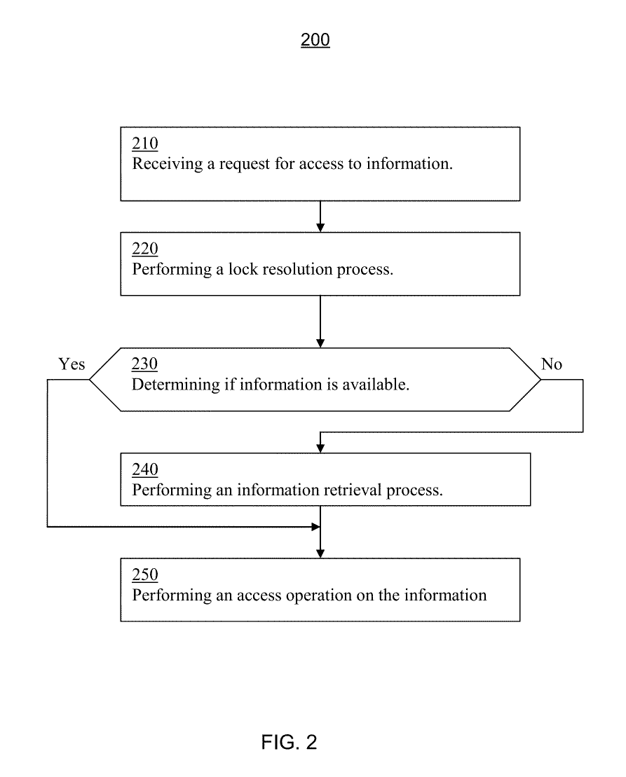

FIG. 2 is a block diagram of an exemplary storage access process 200 in accordance with one embodiment of the present invention. In one embodiment, storage access process 200 facilitates efficient and effective access to information included in shared storage. In an effort to give an overview, a general description of storage access process 200 is presented initially and additional explanation of various aspects of operations (e.g., conflict determination, lock management, etc.) that are compatible with storage access process 200 is set forth in later portions of the detailed description.

In block 210, a request for access to information associated with a shared storage component is received. It is appreciated that a variety of different types of access can be requested (e.g., read access, write access, update access, etc.). In one exemplary implementation, when a transaction to update a record (e.g., a phone number, other fields, etc.) is initiated, a search for an address or indication (e.g., account ID, record number, etc.) corresponding to the particular record is performed and a page that includes the record is determined.

In block 220, a lock resolution process is performed. In one embodiment, a lock resolution process results in an appropriate lock being granted and implemented on a record. In one exemplary implementation, the lock can enable or prevent access to information associated with the record while facilitating efficient and effective coherence and concurrency maintenance. It is appreciated that a variety of different types of locks can be implemented (e.g., P-locks, L-locks, etc.). The lock resolution process can include participating in a lock management process that manages a physical lock (P-lock). In one embodiment, a lock resolution process results in a P-lock being granted without explicitly granting or establishing an L-lock. In one exemplary implementation, the lock management process utilizes transaction information associated with an implicit lock process and proceeds without communication overhead associated with explicit requests for a logical lock. Additional explanation of various aspects of lock resolution process is set forth in later portions of the detailed description.

In block 230, a determination is made if the information is available. In one embodiment, a determination is made if the information is in local cache.

In block 240, an information retrieval process is performed. In one embodiment, information is retrieved from a disk. In one exemplary implementation, the information is retrieved from another component (e.g., a shared storage, another node, etc.).

In block 250, an access operation is performed. It is appreciated that a variety of different types of access operations can be performed (e.g., a read operation, a write operation, an update operation, etc.). The access operation can be directed to the information requested in block 210.

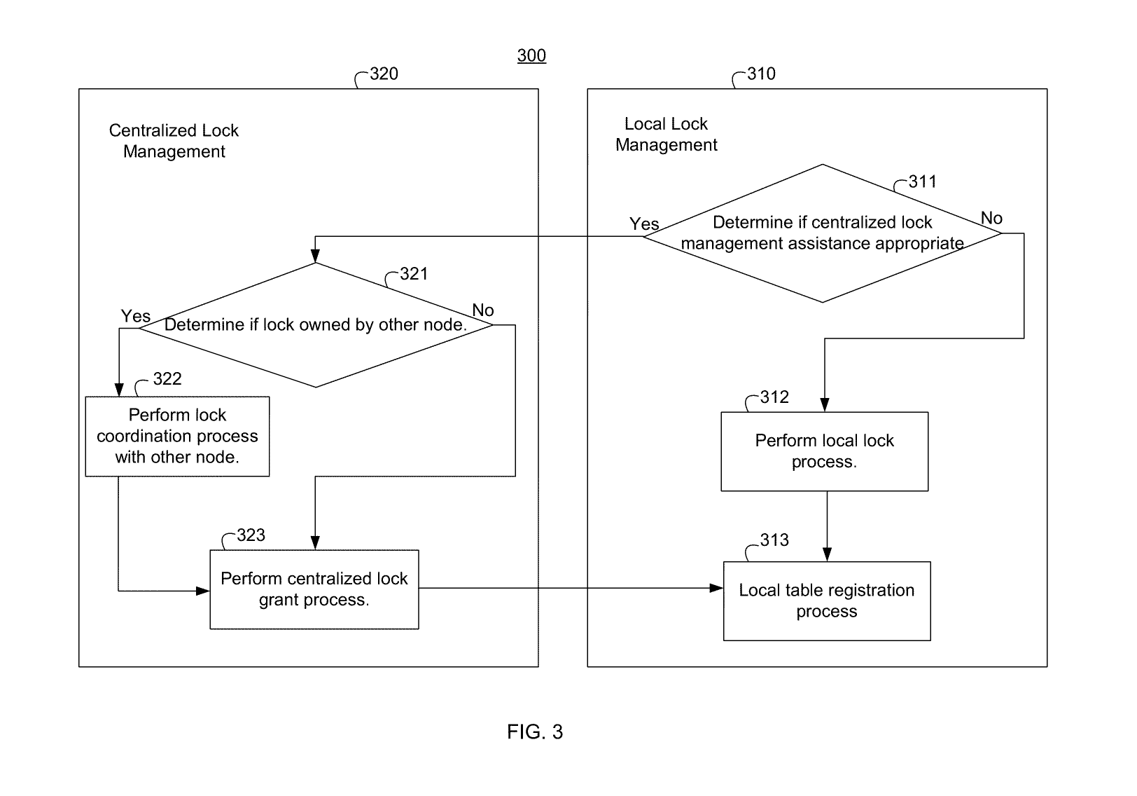

FIG. 3 is a block diagram of exemplary processes in a lock resolution process 300 in accordance with one embodiment of the present invention. In one embodiment, lock resolution process 300 is similar to a lock resolution process performed in block 220.

It is appreciated that the terms centralized lock management process and local lock management process are utilized to indicate a directed emphasis of a lock resolution process rather than an absolute description. In one exemplary implementation, a node can have local components (e.g., local lock manager, etc.) that participate in a centralized lock management process, including coordinating interaction and local lock operations with other components (e.g., a centralized lock manager, another node, etc.). Additional explanation of various aspects of node participation in lock resolution processes is set forth in later portions of the detailed description.

In block 310, a local lock management process is performed. In one embodiment, the local lock management process is performed in a node considered a local node for a particular access.

In block 311, a determination is made if centralized lock management assistance is appropriate. In one embodiment, the determination includes determining if a P-lock is owned locally. If a determination is made that a centralized lock management assistance is appropriate the process proceeds to block 320 centralized lock management. If a determination is made that a centralized lock management assistance is not appropriate the process proceeds to block 312.

In block 312, a local lock process is performed. In one embodiment, the local lock process includes ensuring a P-Lock is established locally. The P-Lock may have been previously established. In one embodiment, a normal protocol of a single node system is followed to gain access to the desired page. In one exemplary implementation, a latch is placed on the page and the page is available for an access operation (e.g., read, update, etc.). After the access operation is complete, the latch is released. In one exemplary implementation, the local lock process includes performing conflict resolution (e.g., based upon transaction information, etc.). A local lock process can pass a P-Lock grant indication to block 313.

In block 313, a local table registration process is performed. In one embodiment the local table registration process includes updating a local lock registration table in accordance with a P-Lock grant indication.

In block 320, a centralized lock management process is performed. In one embodiment, the centralized lock management process is performed in a centralized lock manager and/or other node considered a remote or non-local node for a particular access. In one exemplary implementation, a centralized lock manager can be a global lock manager.

In block 321, a determination is made if a P-Lock is owned by another node. If a P-Lock is not owned by another node the process proceeds to block 323. If a P-Lock is owned by another node the process proceeds to block 322.

In block 322, a lock coordination process with the other node is performed. In one embodiment, the lock coordination process includes getting the other node to release a P-Lock. The lock coordination process can include getting the other node to forward access related information to the local node. In one exemplary implementation, the lock coordination process can include performing conflict resolution (e.g., based upon transaction information, etc.).

In block 323, a centralized lock grant process is performed. The centralized lock grant process includes ensuring a P-Lock is established and passing a P-Lock grant indication to the lock local management block 313

As indicated above, a conflict resolution can be performed. In one embodiment, a potential conflict determination process determines if there is a potential conflict in accessing a record. In one exemplary implementation, the potential conflict determination process utilizes information regarding transactions in the determination operations. The information regarding transactions can be associated with an implicit lock scheme or operations. Additional explanation of various aspects of utilizing information regarding transactions is set forth in later portions of the detailed description.

In one embodiment, if there is not a potential conflict a physical lock process is performed without performing other lock processes (e.g., conventional L-lock processes, etc.). In one exemplary implementation, a pseudo logical lock process and a physical lock process are performed if there is a potential conflict determined. The pseudo logical lock process can be a transaction based logical lock rather than a conventional record based logical lock. In one embodiment, there are very few conflicts and the vast majority of lock resolution process operations proceed to issue a P-lock without executing the pseudo logical lock process. Additional explanation of various aspects of a lock management process is set forth in later portions of the detailed description.

In the relatively rare instances when there is a conflict, a pseudo L-lock process can be performed rather than a conventional L-lock process. In one embodiment, a pseudo L-lock is based on a transaction approach rather than a conventional L-lock based on a record approach. In one exemplary implementation, a pseudo L-lock leverages or utilizes transaction information associated with an implicit lock approach. The utilized or leveraged implicit lock related information can be similar to information used in a conflict determination process (e.g. utilized in block 312, 322, etc.).

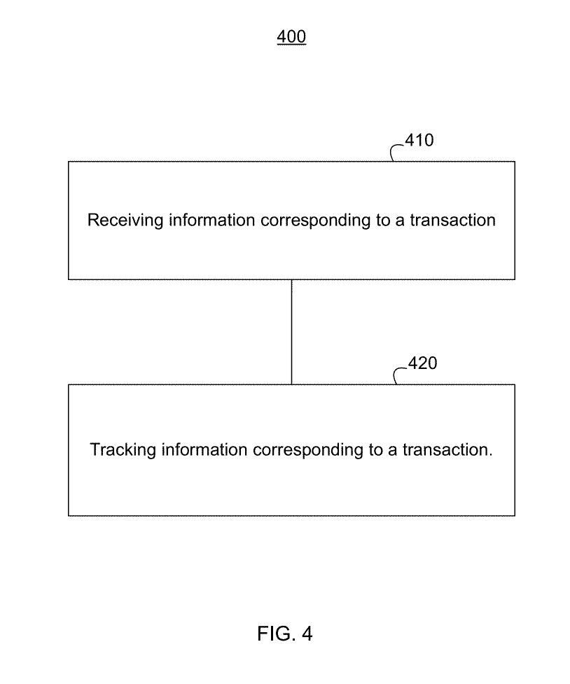

FIG. 4 is a flow chart of an exemplary potential conflict determination process 400 in accordance with one embodiment of the present invention. In one embodiment, potential conflict determination process 400 is similar to operations performed in a potential conflict determination process of block 310.

In block 410, information corresponding to a transaction is received. The information can indicate an association between a record and a transaction. In one embodiment, information associated with an implicit on page lock is received. In one exemplary implementation, a record involved in a transaction is stamped with a transaction ID in a record header, and the updated pages are marked with a page LSN.

In block 420, information corresponding to a transaction is tracked. In one embodiment, an architecture already supports implicit locking and beyond relatively minor additional operations associated with tracking the transaction information for conflict determination, there is no extra lock manager overhead to gather implicit on-page locking. In one exemplary implementation, each node (e.g., 102a, 102b, etc.) can maintain its own log for performance. The status of a transaction can also be centrally maintained (e.g., by central lock manager 150, etc.) in a transaction table.

In one embodiment, an exemplary potential conflict determination process includes recording a transaction ID of a transaction involved in modification of a record, wherein the record is associated with access request. The recording of the transaction ID can be utilized to determine if the transaction has committed the record. A decision or determination is made there is a conflict if the transaction has not committed the record. A decision or determination is made there is not a conflict if the transaction has committed the record.

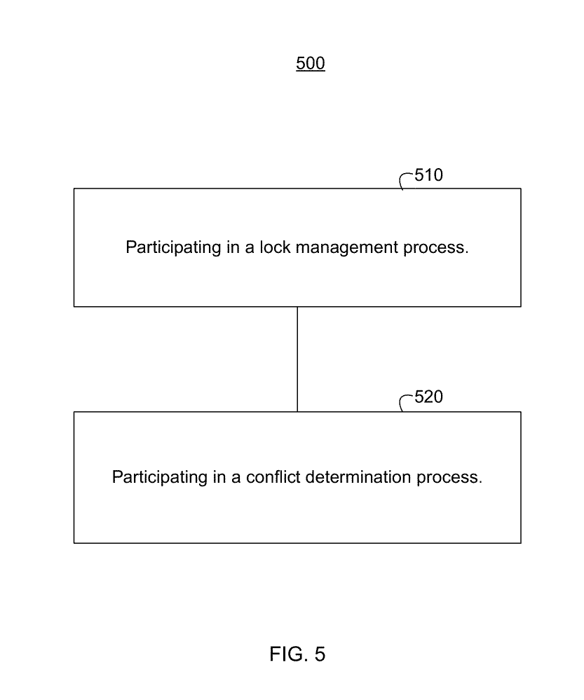

FIG. 5 is a flow chart of an exemplary lock resolution process 500 participation in accordance with one embodiment of the present invention. In one embodiment, lock resolution process 500 is similar to operations performed in a lock resolution process of block 220. In one embodiment, the operations (e.g., tracking transactions, issuing a P-lock, etc.) a component performs while participating in a lock resolution process depend upon the component (e.g., node, centralized lock manager, etc.).

In block 510, a component participates in a lock management process. In one embodiment, the operations a component performs (e.g., checking local cache, issuing a P-lock, etc.) while participating in a lock management process depend upon the component (e.g., node, centralized lock manager, etc.). The operations a component performs while participating in a lock management process can also depend upon the results of a conflict determination process performed in block 520. In one exemplary implementation, if there is no conflict a component only participates in a P-lock process whereas if there is a conflict the component participates in both a P-lock and pseudo L-lock process. Additional explanation of various aspects of an exemplary lock management process is set forth in later portions of the detailed description. In one embodiment, a lock management process can include operations similar to a local lock management process (e.g., similar to block 310, etc.) and a global lock management process (e.g., similar to block 320, etc.).

In block 520, a component participates in a conflict determination process. In one embodiment, the operations a component performs (e.g., issuing a request, tracking transactions, etc.) while participating in a conflict determination process depend upon the component (e.g., node, centralized lock manager, etc.). In one exemplary implementation, a node (102a, etc.) provides information (e.g., transaction information, page information, etc.) to a centralized lock manager (e.g., 150, etc.). The centralized lock manager tracks the information and when a node (e.g., 102b) requests the centralized lock manager to coordinate access to a record, the centralized lock manager (e.g., 150, etc.) checks the information and determines if there is a potential conflict. Additional explanation of various aspects of a conflict determination process is set forth in later portions of the detailed description.

FIG. 6 is a flow chart of an exemplary lock resolution process 700 participation at a local node in accordance with one embodiment of the present invention. In one embodiment, the local lock resolution process is associated with a P-lock request received by a local lock manager (included in a local node), wherein the P-lock request is initiated in and “received” from the local node itself. In one embodiment, the operations can be considered participating in a lock resolution process (e.g., similar to block 230, etc.). In one exemplary implementation, the lock resolution process 700 participation is similar to participation in a local lock management process (e.g., similar to block 310, etc.).

In block 702, a local P-Lock request is received. In block 704, a determination is made if this local node is the P-Lock owner. In one embodiment, a node is the P-Lock owner if the node is an X P-Lock holder. If the P-Lock is not owned locally, the process proceeds to block 722. If the P-Lock is owned locally, the process proceeds to block 712.

In block 712, a determination is made if the P-Lock is held by another transaction. If the page is not currently owned by another transaction, the process proceeds to block 742. If the P-Lock is held by another transaction, the process proceeds to block 714 and waits for the other transaction to release the lock. In one embodiment, grant of a physical lock is stalled until there is not a potential conflict in accessing a record. When the other transaction releases the lock the process proceeds to block 742. Alternatively, a local latch on the page can be applied for mutual exclusion, instead of an explicit local P-Lock.

In block 722, a determination is made if the node is a shared (S) P-Lock holder. The determination can include determining if the node has a cached copy of a page corresponding to the access operations. If the node is not a S P-Lock holder the process proceeds to block 732. If the node is a S P-Lock holder the process proceeds to block 724

In block 724, a determination is made if the page is qualified. In one embodiment, determining if a page is qualified includes determining if the page satisfies a MVCC snapshot requirement. If the page is not qualified the process proceeds to block 732. If the page is qualified the process proceeds to block 742.

In block 732, a P-Lock request is sent to a centralized lock manager. In one embodiment, the centralized lock manager is similar to centralized lock manager 150. In one exemplary implementation, the process waits for a response from the centralized lock manager. In block 734, a P-Lock grant is received from the centralized lock manager (CLM).

In block 742, the new P-Lock holder is registered with a local lock table. In block 752, a response granting a P-Lock is sent to the access requester. In one embodiment, the requester is instructed to receive a page from another previous owner node or read the page from disk.

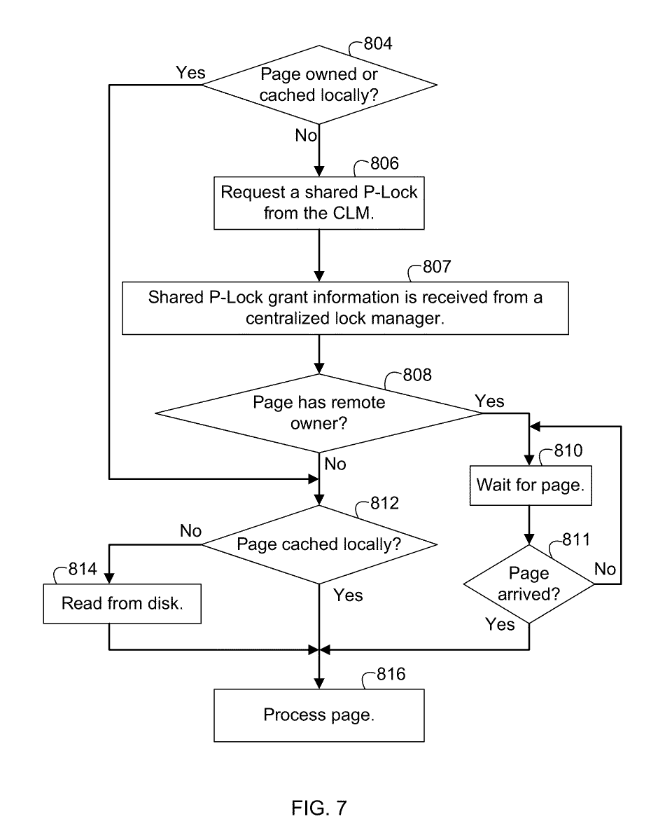

FIG. 7 is a flow chart of an exemplary node participation in a storage access process associated with a read request in accordance with one embodiment of the present invention, wherein the read access is initiated at the local node itself. In one embodiment, operations in blocks 804 through 808 can be considered participating in a lock resolution process (e.g., similar to block 230, etc.), operations in blocks 810, 811 and 814 can be considered performing an information retrieval process (e.g., similar to block 240, etc.), and operations in block 816 can be considered performing an access operation (e.g., similar to block 250, etc.). In one exemplary implementation, the lock resolution process participation is similar to participation in a local lock management process (e.g., similar to block 310, etc.).

In block 802, a page read process is begun. In block 804, a lock determination is made if a particular page is owned or cached locally. In one embodiment, a local lock manager (e.g., 110a, 110b, etc.) makes the determination if a particular page is locally owned. If the page is locally owned or cached, the process proceeds to block 816. If the page is not locally owned or cached, the process proceeds to block 806.

In one embodiment, a node participates in a lock resolution process (e.g., similar to block 230, etc.) by performing operations associated with blocks 806, 807 and 808. In block 806, a request for a shared P-lock from a centralized lock manager is made. In block 807, P-Lock grant information is received from a centralized lock manager. In one embodiment, the P-lock grant information can include a “no owner” indication, “a shared P-lock grant with an LSN” indication, and “owner-ID and a latest LSN” indication. In block 808, a determination is made if a page has a remote owner. In one embodiment, P-Lock grant information received in block 807 from a centralized lock manager is used in block 808 to determine if there is a remote owner. If the requesting node gets a response of no-owner, the process proceeds to block 812. When the requester gets an owner-ID with LSN, the page is considered to have a remote owner. If the page does not have a remote owner, the process proceeds to block 812. If the page does have a remote owner, the process proceeds to block 810.

In one exemplary embodiment, as an optional optimization, a requesting node may also register with the centralized lock manager as a new owner of a page when requesting the shared P-lock. This may be helpful in cases where a requesting node component may subsequently update information or a record on the page.

In one embodiment, a node participates in an information retrieval process (e.g., similar to block 250, etc.) by performing operations associated with blocks 810, 811, 812 and 814. In block 810, the process waits for the page to arrive. In one embodiment, the requester waits for the page to arrive from the owning node. Alternatively, the page may be read from a shared storage (e.g., disk, etc.) and roll-forward to the LSN. In block 811, a determination is made the page arrived. In one embodiment, the determination is made on a periodic basis. If the page has not arrived the process returns to block 810 and waits for the page to arrive. If the page has arrived the process proceeds to block 816. In block 812 a determination is made if the information is cached locally. If the information is cached locally the process proceeds to block 816. If the information is not cached locally the process proceeds to block 814. In block 814 the information is retrieved (e.g., from a remote disk, from a local disk, etc.). In one exemplary implementation, if a shared P-lock is granted the information is retrieved from a shared resource (e.g., shared storage 104, etc.).

In block 816, the page is processed (e.g., read, etc.). In one embodiment, when the information is available locally and does not need a lock grant, a normal protocol of a single node system is performed to gain access to the desired page. In one exemplary implementation, a latch is placed on the page and the page is read. Once the reading is complete, the latch is released.

In one embodiment, reads can be directed to information where there may be multiple cached copies of a single page. When reading a page, a particular page doesn't necessarily have to be the most up-to-date. In one exemplary implementation, for an access involving an information or record update (e.g., modification, etc.) only a single owned copy of a page is possible and when a page is to be updated, the most up-to-date page is updated.

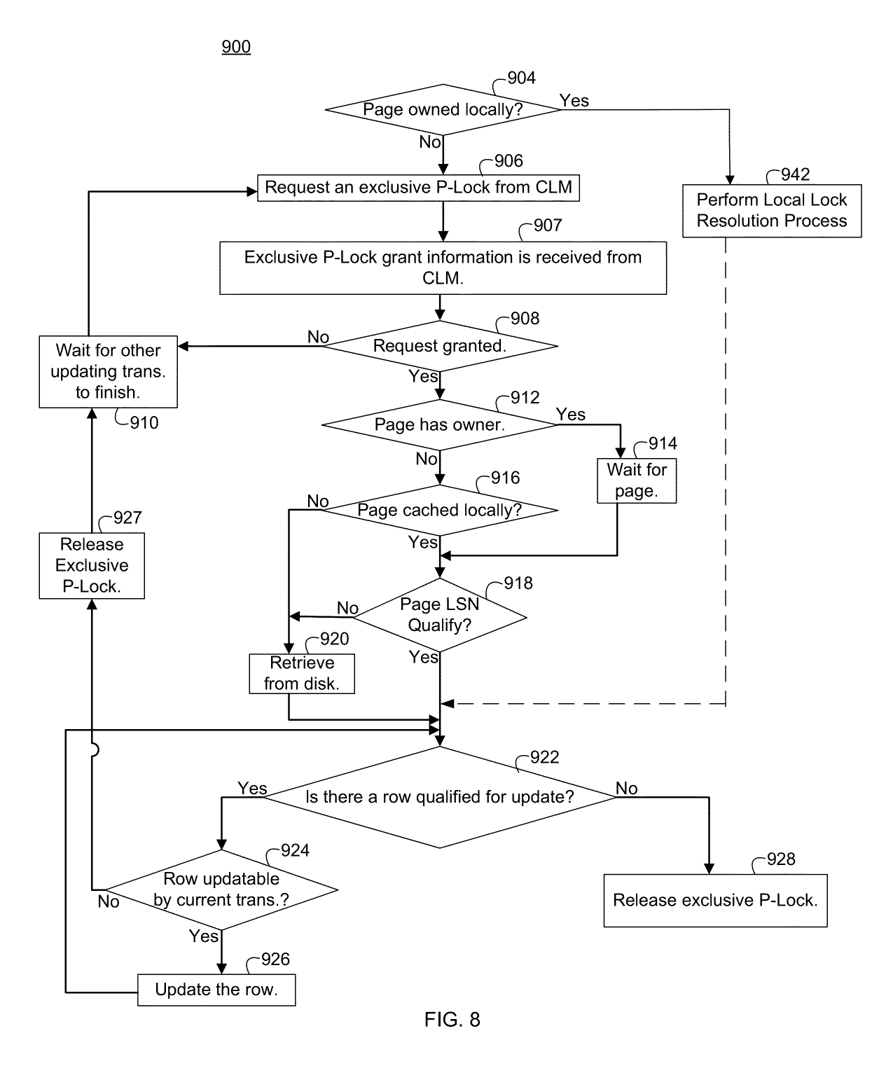

FIG. 8 is a flow chart of an exemplary local node participation in a storage access process associated with an update/modification request in accordance with one embodiment of the present invention, wherein the update/modification access is initiated at the local node itself. In one embodiment, the update is directed to updating a record in a page. In one embodiment, operations in blocks 904 through 912, 916, 918, 922, 924, 927, and 928 can be considered participating in a lock resolution process (e.g., similar to block 230, etc.), operations in blocks 914 and 920 can be considered performing an information retrieval process (e.g., similar to block 240, etc.) and operations in block 926 can be considered performing an access operation (e.g., similar to block 250, etc.). In one exemplary implementation, the lock resolution process participation is similar to participation in a local lock management process (e.g., similar to block 310, etc.).

In block 904, a determination is made if the page is locally owned. In one exemplary process, a local lock manager of a node determines whether the page is locally owned. If the page is not locally owned, the process proceeds to block 906. If the page is locally owned, the process proceeds to block 942 and a local lock resolution process is performed. In one exemplary embodiment, the process may follow the normal protocol of a single node system to gain access to the desired page (e.g., a latch is placed on the page, the page is updated, and once the update is complete, the latch is released). In one embodiment, the process optionally proceeds to block 922 after the local lock resolution process. If the results of block 904 indicate the page is not locally owned, the process continues on to block 906.

In block 906, the process requests an exclusive P-lock for a particular page. In block 907, exclusive P-lock grant information is received from a centralized lock manager. If the lock request is not granted, the process proceeds to block 910 and waits for an updating transaction to finish. If the lock request is granted, the process continues to block 812 to determine whether the information received from the centralized lock manager indicates if the page has another owner (e.g., owned by another node, etc.). If the page has another owner the process proceeds to block 914 and waits for the page. In the page does not have another owner the process proceeds to bock 916.

In block 916, a determination is made if the page is cached locally. If the page is not cached locally the process proceeds to block 920 and the information is retrieved (e.g., from a disk, etc.). If the page is owned locally the process proceeds to block 918. In block 918 a determination is made if the page LSN indicates the page qualifies. If the page does not qualify the process proceeds to block 920 and the information is retrieved. If the page does qualify the process proceeds to block 922. In block 922 a determination is made if there is a row qualified for update. If there is not a row qualified for update the process proceeds to block 928 and the exclusive P-lock is released. If there is a row qualified for update the process proceeds to block 924 and a determination is made if the row is updatable by the current transaction. If the row is updateable by the current transaction the process proceeds to block 926 where the row is updated. After block 926 the process returns to block 920 and the process repeats until no more rows on the page qualify for update.

If the determination in block 924 indicates the row is not updateable by the current transaction the process proceeds to block 927 in which the exclusive lock is released. In block 910 the process waits for another updating transaction to finish. When the other updating transaction finishes the process returns to block 906 and requests an exclusive P lock from the centralized lock manager.

FIG. 9 is a flow chart of an exemplary centralized lock management participation in a storage access process in accordance with one embodiment of the present invention. In one embodiment, operations in FIG. 9 are associated with a centralized lock manager participation in a lock resolution process (e.g., similar to block 230, etc.). In one exemplary implementation, operations in FIG. 9 are similar to participation in a centralized lock management process (e.g., similar to block 320, etc.).

In one embodiment, computer executed process flow of a P-lock request at the centralized lock manager (e.g., 150, etc.). A P-lock request is received in block 1004. In block 1006, a determination is made whether the requested page has an owner. If there is an owner the process continues on to block 1008. If there is not an owner the process proceeds to block 1020.

In block 1020, a determination is made if the request is for an exclusive lock. If the request is not for an exclusive lock the process proceeds to block 1024. If the request is for an exclusive lock the process proceeds to block 1022. In block 1022 the requesting node is registered as the owner. In block 1024, a reply indicating granted and read from disk message is forwarded.

In block 1008, a page owner transfer request process is performed. In one embodiment, a request is sent to the page owner to release or downgrade the lock and transfer the page. In block 1010, a reply is received from the page owner. The reply can include an indication the page owner transfer request is allowed and the latest page LSN. In block 1012 the page LSN is updated. The LSN can be updated in a centralized lock table. The process continues to block 1016 and the P-lock is registered.

In block 1020, a determination is made if the request is for an exclusive lock. If the request is not for an exclusive lock the process proceeds to block 1024. If the request is for an exclusive lock, the process proceeds to block 1022 and the requester is registered as an owner. In block 1024 a reply with the page LSN is forwarded.

In one embodiment, an optional optimization is implemented. If the request includes an indication of an intent to update, the indication is forwarded to the page owner along with the original request so that the page owner can do a conflict determination before granting the request if it chooses to do so (e.g., similar to block 1112, 1114, etc.).

In one embodiment, a shared P-lock request is forwarded to a centralized lock manager. If no one has requested the page before, the centralized lock manager responds with a “grant with no-owner” message. If no one owns the page with an exclusive lock, the centralized lock manager responds with a shared P-lock grant message along with a latest page LSN (if known). If the requested page is owned with an exclusive lock and the owner is on a different node from the requester, the centralized lock manager requests the owner to release the exclusive lock and ship the most recent page to the requester. When the owner responds with a grant message, the centralized lock manager responds to the requester with an owner-ID and a latest LSN.

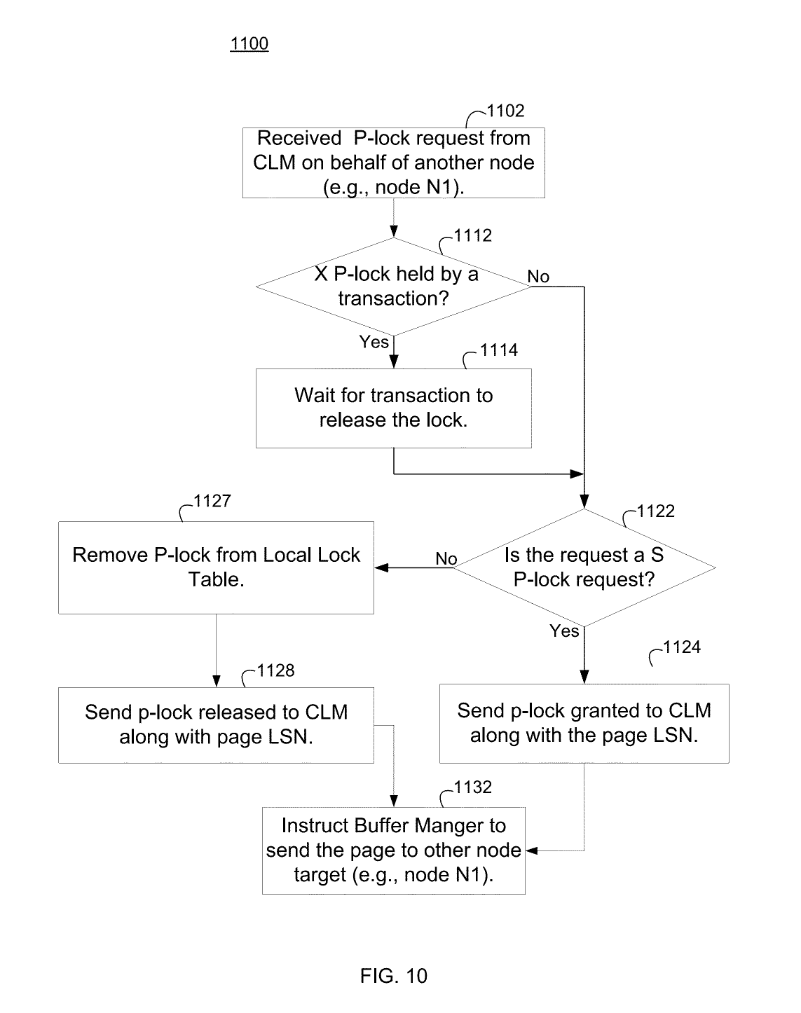

In one embodiment, a node can be considered “a non-initiating” or “non-requesting” node and can participate in a lock resolution process. In one exemplary implementation, a non-requesting node owns a page and participates in a lock resolution process initiated by another node requesting access to the page. FIG. 10 illustrates an exemplary process flow for a P-lock request received by a node in accordance with one embodiment of the present invention. The P-lock request to the node can come from a centralized lock manager.

In block 1102, a P-Lock request on behalf of another node (e.g., node N1) is received from a centralized lock manager at a particular node holding a lock related to an access request (e.g., node N2). A determination is made if an X P-Lock is held by a transaction. If an X P-Lock is not held by a transaction, the process proceeds to block 1122. If an X P-Lock is held by a transaction, the process proceeds to block 1114. In block 1114, the process waits for the transaction to release the lock.

In block 1122, a determination is made if the request is for an S P-Lock. If the request is for an S P-Lock the process proceeds to block 1124. If the request is not for an S P-Lock the process proceeds to block 1127. In block 1127 the P-Lock is removed from the local lock table of the particular node (e.g., node N2). In block 1128, a P-Lock is released to the CLM along with the page LSN. In block 1124, a P-Lock is granted to the CLM along with the page LSN. In block 1132 the buffer manager is instructed to send the page to the target other node (e.g., node N1).

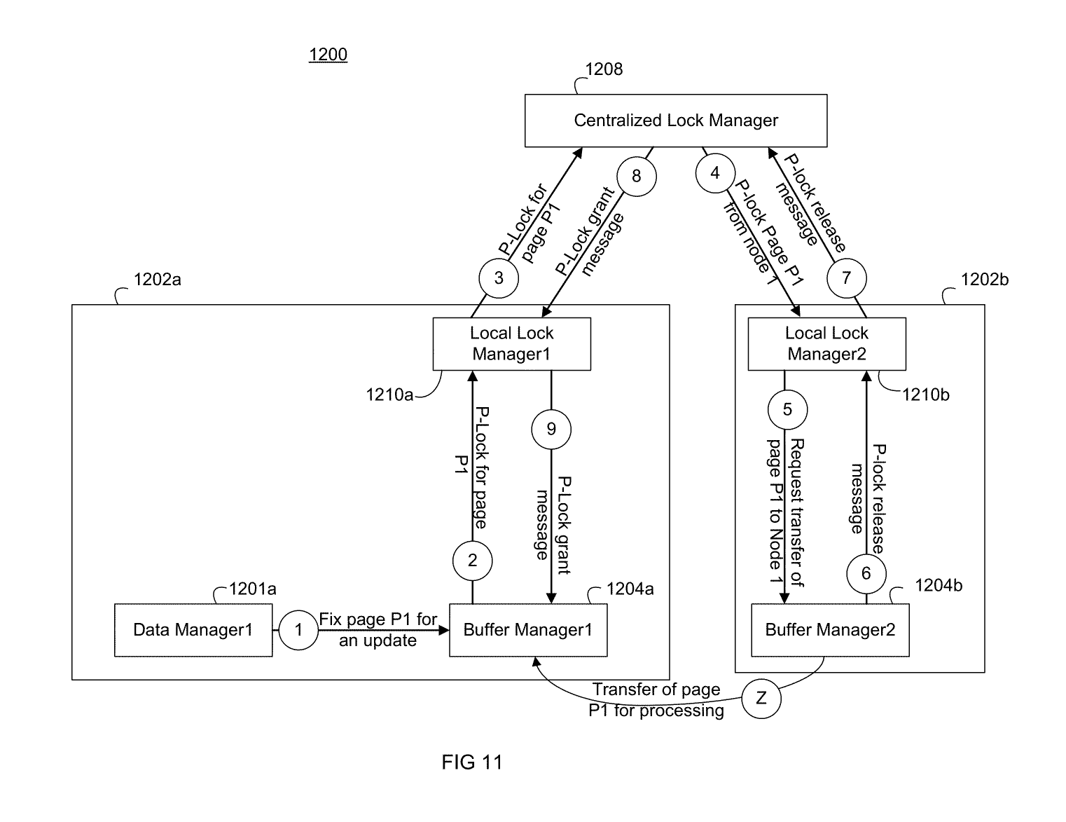

FIG. 11 illustrates an exemplary process flow in accordance with one embodiment of the present invention. In one embodiment, the process flow is between a first Buffer Manager 1204a of a first Node 1202a and a second Buffer Manager 1204b of a second Node 1202b via their respective local lock managers 1210a and 1210b and the centralized lock manager 1208. FIG. 11 illustrates a P-lock without an explicit L-lock request. In one embodiment, the FIG. 11 process flow includes an implicit on-page L-lock capability In one exemplary implementation, transaction X on the first node 1202a wants to update a record R1 on page P1 when record R2 on Page P1 is being updated on the second Node 1202b by transaction Y. The second node 1202b grants an exclusive P-lock when it latches on Page P1. In other words, the process illustrated in FIG. 11 includes avoiding page level conflicts but not record conflicts. As discussed herein, when there is a record conflict, the requester merely waits for the record conflict to be removed.

As illustrated in FIG. 11, a data manager 1201a that is part of a first node 1202b sends a message to a first buffer 1204a of the first node 1202a to fix a page (e.g., page (P1)) for an update. The first buffer manager 1204a of the first node 1202a then sends a message to the first local lock manager 1210a of the first node 1202a requesting an exclusive P-lock for page (P1). The first local lock manager 1210a sends a message to the centralized lock manager 1208a requesting the exclusive P-lock for page (P1). The centralized lock manager 1208a, upon determining that page (P1) is owned by a second node 1202b, sends a message to the second local lock manager 1210b of the second node 1202b, requesting an exclusive P-lock for page (P1) for Node 1202a. The second local lock manager 1210b sends a message to the second buffer manager 1204b requesting the transfer of page (P1) to the first node 1202a.

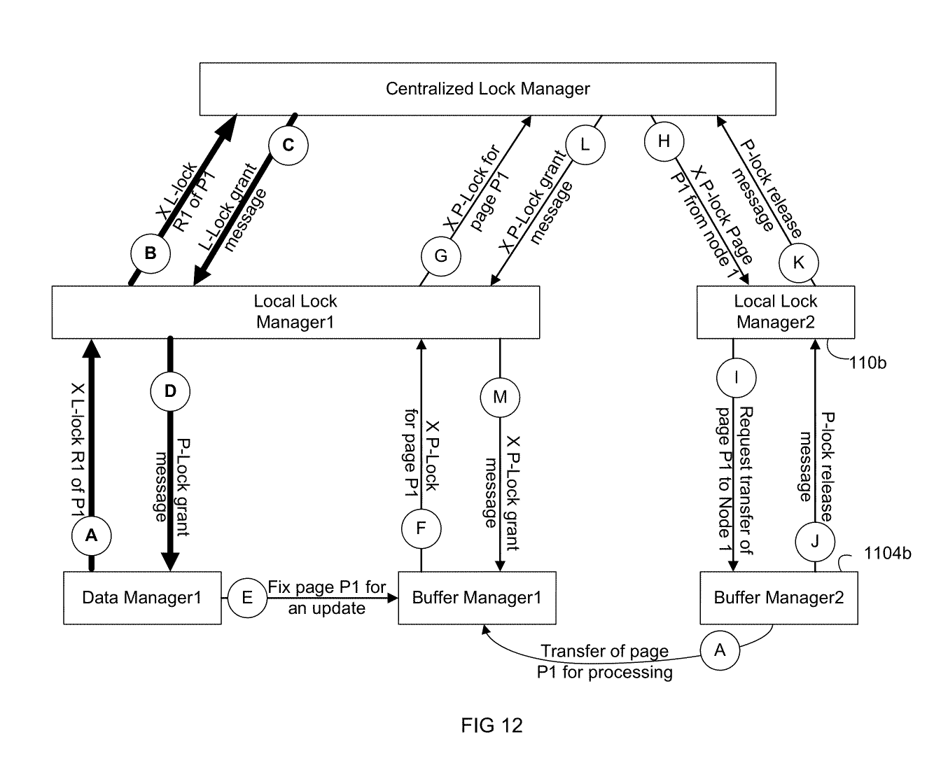

As illustrated in FIG. 11, the second buffer manager 1204b of the second node 1202b sends a P-lock release message to the second local lock manager 1210b of the second node 1202b, which is then transferred to the centralized lock manager 1208. Upon receiving the P-lock release message, the centralized lock manager 1208 sends a message granting an exclusive P-lock to the first local lock manager 1210a of the first node 1202a, which is finally transferred by the first local lock manager 1210a to the first buffer manager 1204a. As also illustrated in FIG. 11, when page (P1) is released by the second node 1202b, page (P1) is transferred from the second buffer manager 1204b of the second node 1202b to the first buffer manager 1204a of the first node 1202a. It is appreciated, the presented new approaches efficiently and effectively perform lock operations with reduced or no overhead associated with conventional L-Lock approaches. In one exemplary implementation, conventional L-Lock approaches (e.g., overhead associated with operations A,B,C, and D) as shown in FIG. 12 are not required in newly presented approaches.

Again, it is appreciated the presented approaches offer efficient and effective information storage concurrency management. In one embodiment, a newly presented approach is more efficient than conventional approaches. In one exemplary implementation, the use of conventional L-locks is reduced or eliminated. This in turn may significantly reduce the overhead (e.g., number of messages, etc.) to a centralized lock manager when acquiring access to information (e.g., a page of records in a shared-disk database cluster, etc.). Further, when compared to conventional processes that use a distributed lock by maintaining a lock table on page, explicit row locks are not used in one exemplary newly presented approach. Instead, the exemplary implementation can stamp the updated row with a transaction ID. Accesses directed to updating or modifying records can be synchronized by waiting on the transaction. As discussed herein, because in most cases there will be no update conflict, a conventional L-lock approach can be reduced or avoided entirely by utilizing implicit on-page locks, which have no or minimal additional lock costs. In one embodiment, if a transaction modifying the record is not finished yet, and there is a conflict, a transaction lock can be requested similar to a single node system.

Embodiments described herein may be discussed in the general context of computer-executable instructions, such as program modules, residing on some form of computer-readable storage medium executed by one or more computers or other devices. By way of example, and not limitation, computer-readable storage media may comprise non-transitory computer-readable storage media. Non-transitory computer-readable storage media includes all computer-readable media except for a transitory, propagating signal. Computer-readable storage media includes volatile and nonvolatile, removable and non-removable media implemented in any method or technology for storage of information such as computer-readable instructions, data structures, program modules or other data. Generally, program modules include routines, programs, objects, components, data structures, etc., that perform particular tasks or implement particular abstract data types. The functionality of the program modules may be combined or distributed as desired in various embodiments.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A storage access process comprising:
receiving an access request to information, wherein the information is associated with a shared storage component;
performing a lock resolution process; wherein the lock resolution process includes participating in a lock management process that manages a physical lock (P-lock), wherein the lock management process utilizes transaction information associated with an implicit lock process and proceeds without communication overhead associated with explicit requests for a logical lock; and
performing an access operation in at least one of a plurality of nodes, the access operation is directed to the information

2. The process of claim 1 wherein at least a portion of the lock management process is performed by a centralized lock management component.

3. The process of claim 1 wherein at least a portion of the lock management process is performed in a node.

4. The process of claim 1 wherein the physical lock is an exclusive physical lock.

5. The process of claim 1 wherein the lock resolution process includes participating in a conflict determination process, wherein the conflict determination process utilizes the transaction information associated with the implicit lock process in determining if there is a potential conflict in accessing a record.

6. The process of claim 5 wherein the lock resolution process includes stalling a grant of the physical lock until there is not a potential conflict in accessing the record.

7. The process of claim 5 wherein the lock management process includes participating in pseudo logical lock (L-lock) process if the conflict determination process determines there is a potential conflict.

8. The process of claim 5 wherein the conflict determination process comprises:
recording a transaction ID of a transaction involved in modification of a record, wherein the record is associated with access request;
utilizing the recording of the transaction ID to determine if the transaction has committed the record;
determining there is a conflict if the transaction has not committed the record; and
determining there is not a conflict if the transaction has committed the record.

9. The process of claim 1 wherein the page includes a plurality of records stored in a shared storage.

10. A system comprising:
a processing component configured to perform operations in accordance with instructions; and
a memory configured to store information associated with the instructions and the operations, the instructions directed to performing a lock resolution process including;
participating in a lock resolution process, wherein the lock resolution process includes establishing a lock on a record in the memory utilizing a physical lock (P-lock), wherein the lock resolution process uses transaction information associated with an implicit lock process and proceeds without communication overhead associated with explicit requests for a logical lock.

11. The system of claim 10 wherein the lock resolution process includes performing a physical lock (P-lock) process without establishing a logical lock (L-lock) first.

12. The system of claim 11 wherein the processing component and the memory are included in a centralized lock management component.

13. The system of claim 10 wherein the participating in the lock resolution process includes:
receiving a P-lock request from a requesting node;
determining if a page associated with the P-lock request has an owner;
performing a page owner transfer request process if the page has an owner;
registering a P-lock if the page owner transfer request process is allowed;
registering the requesting node as the owner if the P-lock request is for an exclusive type lock;
replying with a page log serial number (LSN).

14. The system of claim 10 wherein the lock resolution process includes participating in a conflict determination process, wherein the conflict determination process utilizes the transaction information associated with the implicit lock process in determining if there is a potential conflict in accessing a record.

15. The system of claim 14 wherein the participating in the conflict determination process includes maintaining an indication of a transaction status.

16. The system of claim 10 wherein the processing component and the memory are included in a local lock management component.

17. A lock resolution method comprising:
participating in a lock management process, including participating in a physical lock (P-lock) process, wherein the physical lock process proceeds without communication overhead associated with explicit requests for a logical lock; and
participating in a conflict determination process to determine if there is a potential conflict with an information access request, wherein the conflict determination process utilizes transaction information associated with an implicit lock process.

18. The method of claim 17 wherein at least a portion of the lock resolution process is performed in a centralized lock management component.

19. The method of claim 17 wherein at least a portion of the lock resolution process is performed in at least one of a plurality of nodes.

20. The method of claim 19 wherein at least another portion of the lock resolution process is performed in the at least another one of a plurality of nodes.
